(19) United States
(12) Patent Application Publication
(10) Pub. No.: US 2012/0206906 A1
(43) Pub. Date: Aug. 16, 2012

(54) Portable Lighting Apparatuses and Methods

(76) Inventor: Ralph Randy Gindi, Brooklyn, NY (US)

(21) Appl. No.: 13/027,007

(22) Filed: Feb. 14, 2011

(51) Int. Cl. F21V 21/08; F21L 4/06; A01K 27/00; F21L 4/00

(52) U.S. Cl. 362/103; 362/157; 362/190; 362/158; 119/794

(57) ABSTRACT

The present invention is related to the field of portable lighting apparatuses and methods, in particular, apparatuses that are useful for illuminating in the dark, such as at night or in dark spaces; as well as for athletic and physical activities for which illumination is useful. In certain embodiments, the present invention is directed to an illuminating device that is portable and motion activated. Such a device may be useful for pet applications such as collars and leashes, or for human applications such as charms for illuminating in low visibility conditions including sports and law enforcement situations.

### BACKGROUND OF THE INVENTION

The present invention is related to the field of portable lighting apparatuses and methods, in particular, apparatuses that are useful for illuminating in low visibility conditions, such as at night or in dark spaces; as well as for athletic and physical activities for which illumination is useful.

Portable lighting and illumination devices have wide applications. Such devices typically include a power source such as a battery, and may be switched on and off as the need arises. However, the need to replace the battery makes such devices inconvenient for long periods of use. Further, pet owners often wish to protect their pets while outdoors by providing them with portable lighting devices; however, pets are incapable of switching the devices on and off.

Thus, a need remains for portable lighting apparatuses that are light and easy to carry, have a consistent and reliable power source, and that are motion sensitive, thus reducing the need for switching on and off in the case of a user (such as a pet) who is incapable of switching, or while engaged in other activities in the case of a user (such as a human) who may not wish to switch the lighting apparatus on and off for safety or convenience reasons.

### SUMMARY OF THE INVENTION

In certain embodiments, the present invention is directed to a portable lighting apparatus comprising a motion activated light emitting diode (LED) light source.

In other embodiments, the present invention is directed to a portable illuminating device comprising a charm, the charm comprising a front shell portion and a back shell portion, and a lighting portion sandwiched between the front shell portion and the back shell portion; the lighting portion comprising a motion activated light emitting diode (LED) light source.

In other embodiments, the present invention is directed to a handheld pet device comprising:

(a) a handle for a human user;

(b) housing connected with or integrated with the handle, the housing containing a flashlight apparatus and a bag dispenser in its interior, and a lighting apparatus on its exterior; and

(c) a retractable leash capable of being housed within the housing's interior.

### BRIEF DESCRIPTION OF THE DRAWINGS

FIG. 1a shows a close up of a lighting apparatus in accordance with certain embodiments of the present invention. FIG. 1b shows a close up of a light emitting diode (LED) in accordance with certain embodiments of the present invention.

FIG. 2 shows an embodiment of the present invention wherein a lighting apparatus forms part of a harness assembly for a pet.

FIG. 3a shows an embodiment of the present invention wherein a lighting apparatus forms part of a pet clothing assembly. FIG. 3b shows an embodiment of a pocket forming part of the pet clothing assembly that display a lighting apparatus in accordance with certain embodiments of the present invention.

FIG. 4a shows an embodiment of the present invention wherein a lighting apparatus forms part of a collar assembly for a pet. FIG. 4b shows the detail of the collar assembly pictured therein.

FIG. 5 shows a combination retractable leash with lighting apparatus and bag dispenser in accordance with certain embodiments of the present invention.

FIG. 6 shows an embodiment of the present invention wherein a lighting apparatus forms part of an illumination device usable by a human engaged in an athletic or sporting activity.

FIG. 7 shows an embodiment of the present invention wherein a lighting apparatus forms part of an illumination device usable by a human engaged in an athletic or sporting activity.

### DETAILED DESCRIPTION OF THE INVENTION

The lighting apparatuses of the present invention comprise one or more lighting elements. In various embodiments, one or more of such lighting elements are light emitting diodes (LEDs).

### Light Emitting Diodes (LEDs)

In certain embodiments, the lighting elements of the present invention are light emitting diodes (LEDs). LEDs are advantageous for the lighting apparatuses and methods of the present invention for several reasons; among them, ease of use, low cost, and portability (making them desirable for applications that involve movement). Moreover, LED batteries are small, lightweight, cheap and tend to last a long time.

In various embodiments, the lighting elements may blink (either at regular intervals or intermittently), or may emit a steady light. In various embodiments, the lighting elements may be of any color that renders the wearer easily visible in low visibility conditions such as darkness, rain or fog or other weather conditions, or may be of varying colors to provide a visually desirable pattern. The LEDs in accordance with the embodiments of the present invention may, in the case of more than one LED, be in a series. In certain embodiments, one or more resistors may be present to regulate the amount of power provided to each LED.

In certain embodiments, one or more of the lighting elements may be motion activated. That is, no manual switching on and off is required. This provides for a fully hands-free apparatus, which as discussed previously, can be advantageous in the case of a pet (who cannot switch a lighting apparatus on and off), or a person who is using the lighting apparatus for an athletic or sporting activity that requires the use of both arms to maximize safety (for example, skiing, hiking, mountain climbing, camping, bicycling and the like). In such embodiments, the lighting apparatus will light up upon sensing movement from the user. Such lighting apparatus typically comprises a motion sensor that utilizes ultrasound, infrared or any other suitable form of energy, and which is coupled to the LED, such that the motion sensor senses movement and is activated thereto. Such activation will in turn switch on the LED for a given period of time, either as a steady light or as a blinking light. Of course, in certain embodiments, the motion sensor may be overridden with a manual switch, to provide maximum flexibility to meet a user's needs. In various embodiments, the motion sensor may further comprise, or be used in conjunction with, a flashing timing unit that permits a strobe or timed oscillation of light; however, in other embodiments, such a flashing timing unit is not present and the motion sensor may be completely free of any timing mechanisms.

In certain embodiments, a lighting apparatus may comprise a plurality of lighting elements, one or more of which is motion activated and one or more of which is switch activated. In such an embodiment, the lighting apparatus will never be completely without illumination during use, but activation of the motion activated lighting elements may provide additional, supplemental illumination for, e.g., signaling movement.

### Pet Applications

In certain embodiments, a lighting apparatus of the present invention is attached or integrated into a collar such as, for example, a collar for a pet. In various embodiments, the collar may be made of leather, nylon, or any flexible and lightweight material, including metal. In various embodiments, the collar may include a buckle, a knot (including a slip knot), a snap, a button, hook and loop fastenings (for example, Velcro®), a snap fastening, or in the case of a metal collar, may be flexible such that the pet owner can stretch it into an open position, position it around the pet's neck or elsewhere on the pet's body (for example, its torso or leg) and then push it into a tighter, more closed position. As another example, the collar may be made of flexible, elastic material that can be stretched to an widened position when affixing to a pet's body, and then snapped into an unstretched, tightened position when affixed to the pet's body.

As a further example, a lighting apparatus of the present invention may be attached or integrated into any portion of a leash assembly. As used herein, “leash assembly” means an assembly for leashing and controlling a pet such as, but not limited to, a dog or a cat. A leash assembly may include any of the following: a leash, a collar, a handle, a muzzle, a harness or any other components that are customarily used together to leash and control the pet. For example, in certain embodiments, a lighting apparatus of the present invention may be attached to, or integrated with, a leash, a collar, or the leash or collar portion of a leash assembly.

In an exemplary embodiment, the leash comprises a lighting apparatus in a desirable shape such as a paw print, a bone, a flower or the like, and the pet owner can view illumination along any portion of the length of the leash, such that when he is walking his pet in low visibility conditions, the connection of the pet to the owner is always visible. This is especially useful if the pet moves around often, as it permits the owner to maintain constant surveillance of the pet's position.

In another exemplary embodiment, the collar or leash comprises a lighting apparatus that is attached to the leash assembly, for example, sewn, adhered, magnetically attached, clamped, or sandwiched between the collar or leash and a screened patch shape overlying the lighting apparatus. In another embodiment, the lighting apparatus may form part or all of a device such as a charm or plate, which is itself attached to the collar or leash or leash apparatus. In such an embodiment, the position of the pet can be immediately discerned in low visibility conditions via an illuminated portion that is more or less directly on the pet's body.

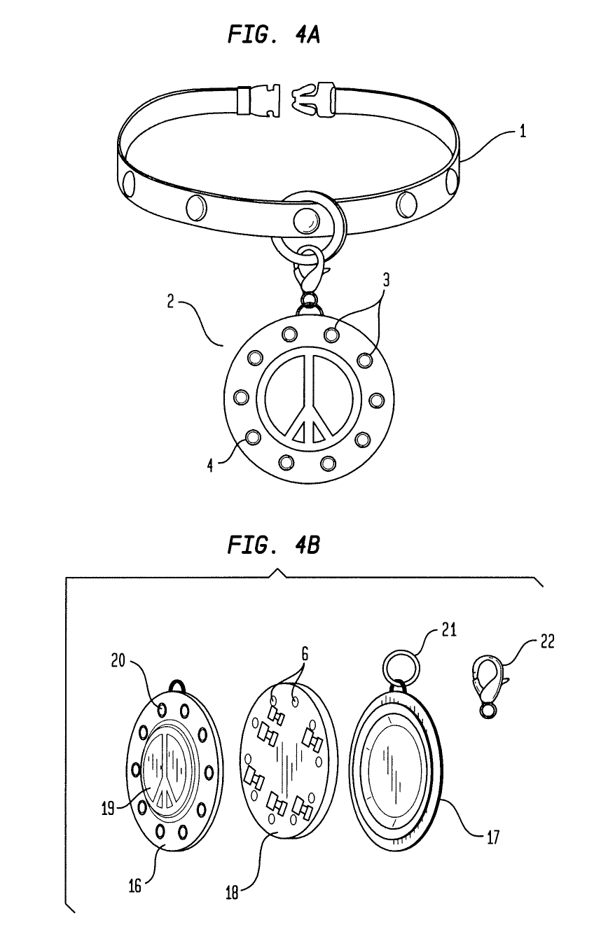

An example of a leash assembly comprising a lighting apparatus of the present invention can be seen in FIG. 4a, which shows certain embodiments of the present invention wherein a lighting apparatus is attached into a leash assembly. As can be seen from FIG. 4a, the leash assembly includes a collar 1 that goes around the pet's neck or other part of the pet's body, as well as a display portion 2 that hangs from the collar and is visible when viewing the pet from the front. The display portion shown in FIG. 4a is in the form of an illuminating device (such as a charm, as will be discussed further in the disclosure)—in this case, a circle with a “peace” symbol; however, the charm may be of any shape desirable to a pet owner. For example, in an alternative embodiment not shown, the charm may be in the shape of a dog bone, or a heart, clover, flower or any other desirable shape. In the embodiment depicted, each lighting apparatus 3 can be seen on the front of the display portion. Half of the lighting apparatuses displayed are presented as blinking studs 4.

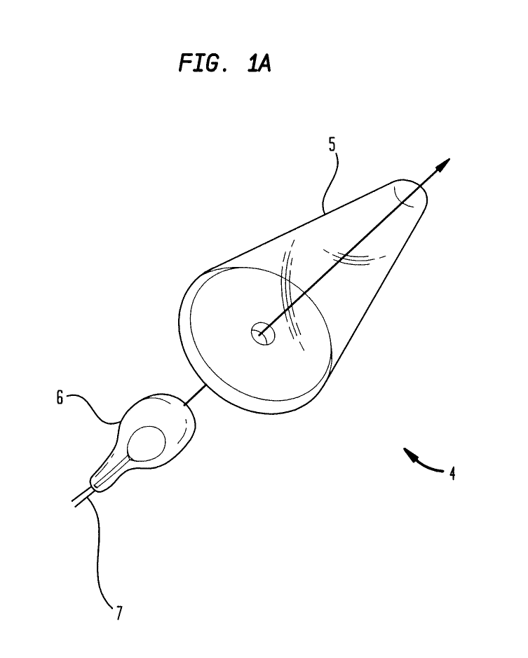

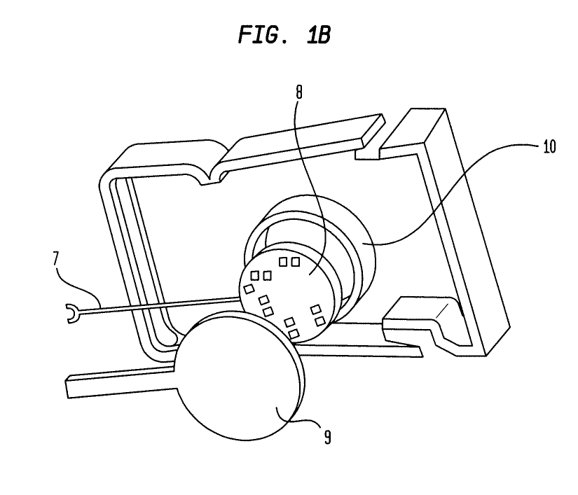

FIG. 1a is a close up of a blinking stud 4 in accordance with certain embodiments of the invention. As can be seen in the embodiment shown, the blinking stud includes a protective cover—in the embodiment shown, the protective cover includes a clear plastic spike stud 5. This clear plastic spike stud is disposed over a red light emitting diode (LED) 6. Power leads 7 connect the LED to a power source. In certain embodiments, the LED power source may be a battery and may provide, in various embodiments, about 1 to about 12 volts, about 2 to about 6 volts, about 3 to about 5 volts, or about 4 volts. The leash assembly and light apparatus are configured such that the wearer of the collar is highly visible in a low visibility environment.

FIG. 1b shows a close up of an LED as part of the lighting apparatus in accordance with certain embodiments of the invention. Power leads 7 connect the LED 6 (not visible in this Figure) to a power supply 8. The power supply 8 is covered with a housing and channel cap 9 and a power supply housing 10.

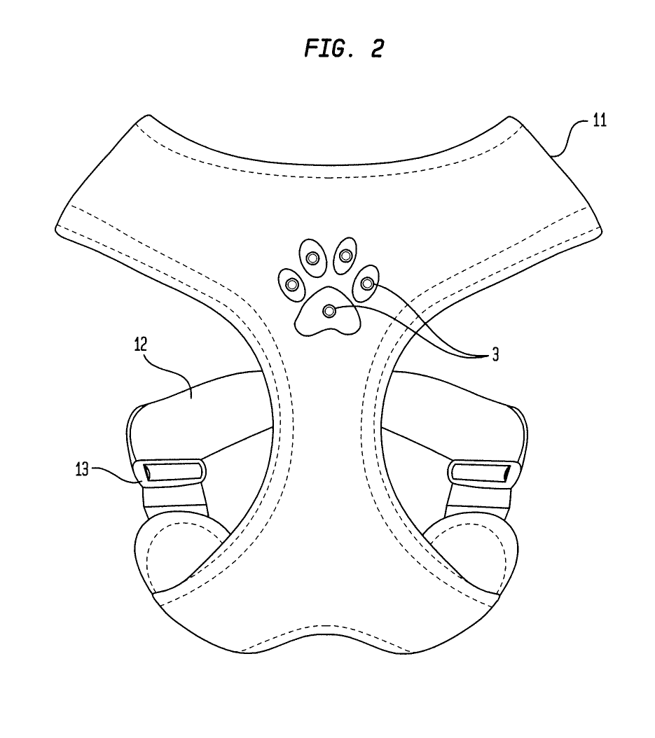

In another embodiment, shown in FIG. 2, the lighting apparatus is attached to or embedded within a harness 11 that fits snugly around the pet's body and is attached by an adjustable belt 12 having one or more buckle clips 13. The harness may be, in various embodiments, made in part or whole of any material that is flexible and compatible with a pet's body—for example, soft fabric, leather, plastic or other polymeric material or metal. In this embodiment, the lighting apparatuses 3 are disposed within the fabric of the harness, and include protective covers that are, in various embodiments, substantially flat and substantially in alignment with the plane of the harness, or substantially dome-shaped and protruding from the plane of the harness.

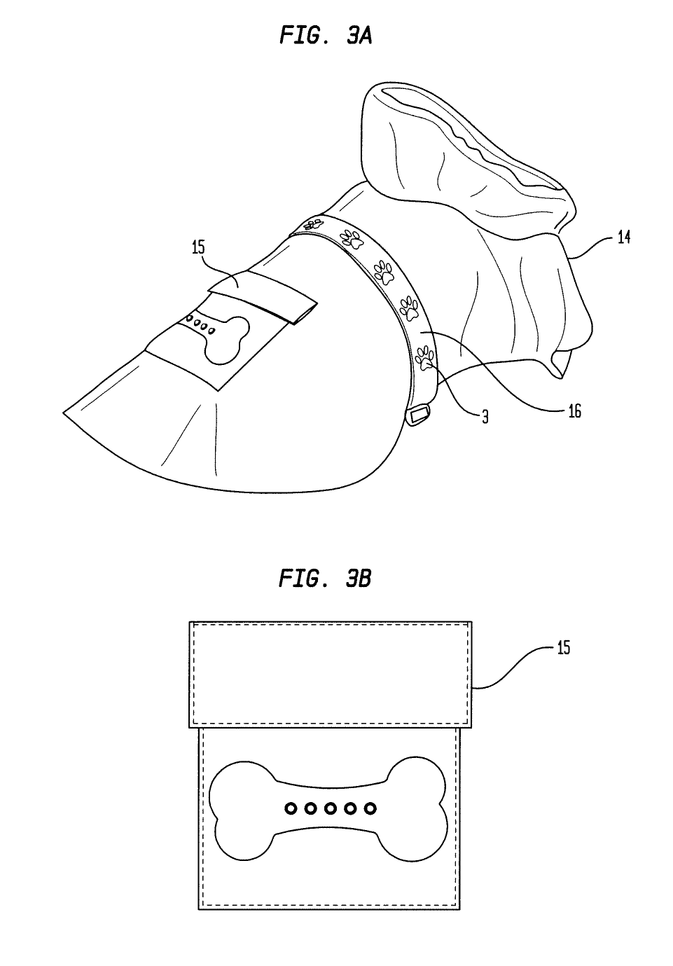

In other embodiments, a lighting apparatus of the present invention may be attached or integrated into any portion of a pet clothing assembly 14. For example, in certain embodiments, a sweater, jacket or coat for a pet comprises a lighting apparatus. An example is shown in FIG. 3a, where a windbreaker/rain slicker 14 for a pet can be seen that comprises a pocket 15 into which one or more lighting apparatuses may be sewn or otherwise adhered. In the embodiment shown in FIG. 3a, further lighting apparatuses 3 are displayed visually as a set of reflective “paw prints” along a belt 16 encircling the pet clothing assembly 14. Other lighting apparatuses may be incorporated into, or attached on, any other part of the pet clothing assembly 14. In certain embodiments, a leash assembly may be integral with the pet clothing assembly 14. FIG. 3b shows various embodiments of the pocket 15, wherein the lighting apparatuses are disposed in a shape of a bone. In both of these shown embodiments, the LEDs may be blinking or may provide a steady light, and may be sewn into the pocket 15, or adhered to the pocket with an adhesive or other form of attachment such as, e.g., a clamp, a pin, a magnet or a loop and hook attachment (for example, products commercially available under the trade name Velcro®). Any portion of the assembly may comprise one or more lighting apparatuses, in any configuration that is desirable for illumination. The pocket has a variety of potential uses—for example, to hold or store any portion of the leash assembly, to hold treats or pet food or any other items for convenience.

FIG. 4b shows the detail of an exemplary display portion in accordance with certain embodiments of the present invention—in this case, a portable illuminating device, for example, a charm that hangs from the pet collar or from an article of clothing or equipment for human use. In the embodiment shown, the charm comprises a front shell portion 16 and a back shell portion 17, with a light unit 18 sandwiched between the front shell portion and back shell portion. The front shell portion 16 may comprise a decorative portion 19, for example, screen art. In the embodiment pictured, the screen art presents a “peace” sign, but other embodiments contemplate words, pictures, jewelry, gemstones, or any visually or texturally desirable decoration. In certain embodiments, either or both of the front shell portion 16 and back shell portion 17 may be made of any material that is lightweight and convenient to handle, for example, metal, plastic or other polymeric material, wood, glass, or ceramic. In certain embodiments, either or both of the front shell portion and back shell portion may comprise one or more light holes 20, though which the LED lighting apparatuses may be visible; and the front shell portion and back shell portion may be attachable to each other via a heat seal, adhesive, clamp, nail, screw, snap or magnet. As can be seen in FIG. 4b, the light unit 18 may be sandwiched between the front shell portion and the back shell portion. Thus, in certain embodiments, the front shell portion and back shell portion may be attachable to each other via any mechanism that will permit detachment of the two whenever desired, for example, to replace or repair the light unit 18. The light unit 18 may have disposed within it or on its surface one or more LEDs 6. The charm may hang from the pet collar or human clothing article or equipment via an attachment such as a jump ring 21 and/or a lobster claw attachment 22, or any attachment known in the art.

In another embodiment, a lighting apparatus of the present invention may comprise a pet charm or toy that is not attached to a collar or leash, but that is freestanding and which a pet can play with—for example, a ball or a bone; or artificial objects that are made to look like actual objects, such as an artificial animal, an artificial human figure, an artificial bone; or other toy that blinks or lights up when touched by the pet.

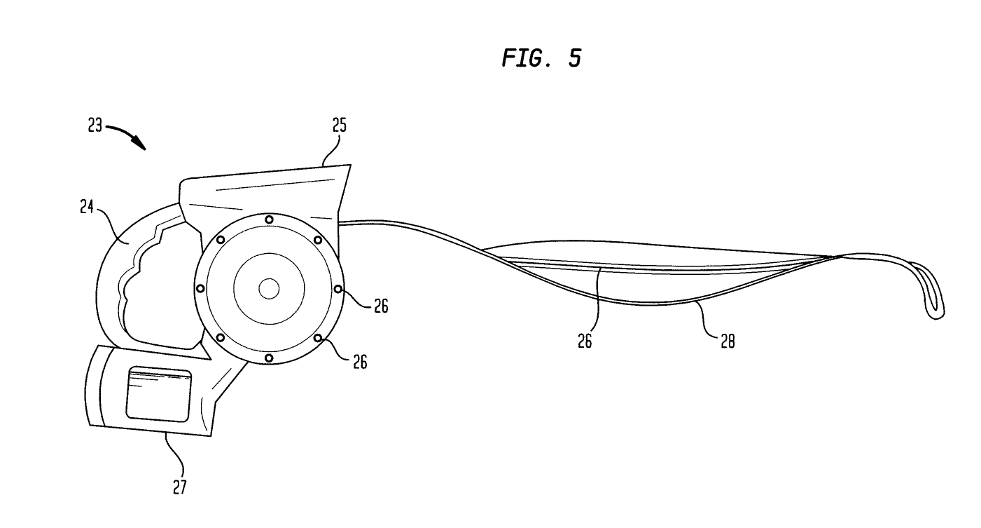

As shown in FIG. 5, in certain embodiments, the lighting apparatus may form part of a handheld device, for example, a combination leash/bag dispenser. As shown there, a handheld device 23 comprises a handle 24, a flashlight apparatus 25 (in certain embodiments, contained within a housing) that provides illumination in a forward direction when the pet owner holds the handle 24, and lighting apparatuses 26 along the exterior of the handheld device 23. The handheld device may further comprise a bag dispenser 27 that holds and dispenses one or more plastic bags with which the pet owner can scoop the pet's waste while walking the pet. The handheld device further comprises a retractable leash 28, which attaches to, and is rolled within the interior of the handheld device. The leash 28 may be made of nylon, polymeric material, fabric or any other strong and durable material.

The interior of the handheld device may also comprise a power supply to power any or all of the flashlight apparatus 25 and the lighting apparatuses 26; however, the flashlight apparatus and the lighting apparatuses may be powered by multiple power supplies. For example, in certain embodiments, the flashlight apparatus 25 may be powered by one or more standard lithium (for example, AAA, AA, A, B or C) batteries or a 9 Volt battery, while the lighting apparatuses 26 along the exterior of the handheld device may be powered by one or more LED batteries. In such an example, the flashlight apparatus may comprise an on/off switch, and the lighting apparatuses may be motion activated. However, the invention is not so limited; in other embodiments, all of the lighting apparatuses may be controlled by the same power source and may all be motion activated or all activated via an on/off switch. Further, the leash assembly may itself comprise additional lighting apparatuses, as discussed elsewhere in the present disclosure. For example, in FIG. 5, the leash assembly includes an additional lighting apparatus 26 in the form of a continuous strip of light, or a line made up of individual lighting apparatuses such as LEDs. Any or all of these apparatus can be controlled by motion activation, manual switching, or a combination of the two.

### Illuminating Devices for Pet and Human Use

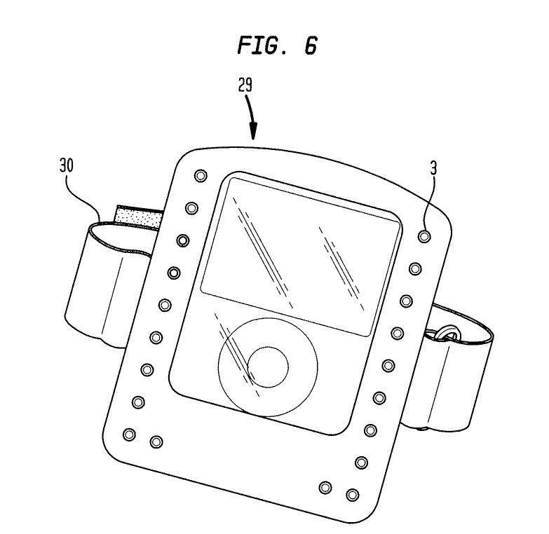

In other embodiments, the lighting apparatus may be formed as part of an illuminating device—such as, e.g., charm, ornament or similar device—for example, a carabiner or other device that can be attached to sporting apparel, e.g., as a zipper pull or accessory. Any person or animal engaging in any activity for which portable illumination would be desirable may use such a device—for example, sports activities, recreational activities, law enforcement, search and rescue or the like. Such devices may be useful for running, snowboarding, skiing or camping; any athlete may attach the illuminating device to his or her zipper, jacket or other equipment to provide lighting when engaging in such activities. As shown in FIG. 6, an embodiment of the present invention contemplates a lighting apparatus that forms part of a running device 29 that a runner can wear on his or her body while running. The running device may be made of any material that is durable and convenient to use—for example, plastic or polymeric material or fabric such as nylon—and may comprise one or more lighting apparatuses 3, an adjustable band 30, and in certain embodiments may be configured to hold a portable music player, for example, an mp3 player or radio.

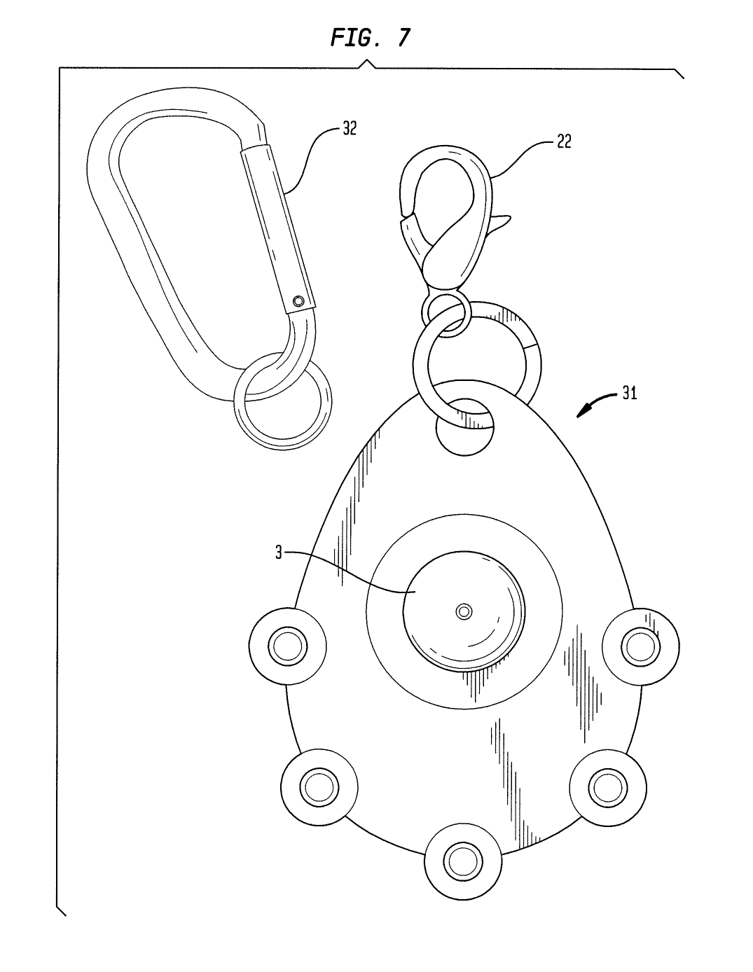

As a further example, as shown in FIG. 7, a lighting apparatus of the present invention forms part of a device 31 that can easily be snapped or otherwise attached onto a user's clothing or other equipment for athletic use. The device 31 may have one or more lighting apparatuses 3 and may, in certain embodiments, be attachable to a carabiner 32 and/or a lobster claw 22 which provides for added convenience. In this manner, a user may be able to engage in athletic activity in low visibility conditions, as well as law enforcement, search and rescue or other uses.

In certain embodiments, a portion or all of a lighting apparatus of the present invention may be substantially waterproof—that is, contact with water or other liquids will not substantially damage it. To that end, in certain embodiments the LEDs may be sealed into the lighting apparatus or illuminating device in a manner that they will not be easily damaged by water, fire, pressure or handling. Further, in various embodiments where the lighting apparatuses of the present invention are attached to, or integrated with, other devices such as leashes, zippers, or athletic equipment, their increased durability will add to their desirability and usefulness.

All embodiments described herein are illustrative and in no way limit the scope of the invention, and the invention may be embodied in other forms not explicitly described here, without departing from the spirit thereof.

What is claimed:

1. A portable lighting apparatus comprising a motion activated light emitting diode (LED) light source.

2. The portable lighting apparatus of claim 1, wherein the motion-activated light emitting diode (LED) light source is capable of providing a blinking light.

3. A pet collar comprising the portable lighting apparatus of claim 1.

4. A pet leash assembly comprising the portable lighting apparatus of claim 1.

5. A pet toy, wherein the pet toy is chosen from a ball, an artificial animal, an artificial human figure, a real or artificial bone, or a shoe; wherein the pet toy comprises the portable lighting apparatus of claim 1.

6. The portable lighting apparatus of claim 1, comprising:
(a) a power supply housed within a power supply housing;
(b) a power lead connecting the LED light source to the power supply and contained within a lead channel; and
(d) a housing and channel cap covering the power supply.

7. The portable lighting apparatus of claim 1, comprising a blinking spike stud.

8. The portable lighting apparatus of claim 1, wherein the portable lighting apparatus is substantially waterproof.

9. The portable lighting apparatus of claim 1, wherein the portable lighting apparatus is integrated into a fabric sleeve capable of holding a portable music player or radio.

10. A portable illuminating device comprising a charm, the charm comprising a front shell portion and a back shell portion, and a lighting portion sandwiched between the front shell portion and the back shell portion; the lighting portion comprising a motion activated light emitting diode (LED) light source.

11. The portable illuminating device of claim 10, wherein the front shell portion or the back shell portion comprises a light hole through which the light emitting diode (LED) light source is visible.

12. The portable illuminating device of claim 10, wherein the light emitting diode (LED) light source is capable of providing a blinking light.

13. The portable illuminating device of claim 10, wherein the charm is connected to a pet collar.

14. The portable illuminating device of claim 13, wherein the pet collar forms part of a pet leash assembly.

15. The portable illuminating device of claim 10, wherein the charm is connected to a zipper, carabiner or article of clothing.

16. A handheld pet device comprising:
(a) a handle for a human user;
(b) housing connected with or integrated with the handle, the housing containing a flashlight apparatus and a bag dispenser in its interior, and a lighting apparatus on its exterior; and
(c) a retractable leash capable of being housed within the housing's interior.

17. The handheld device of claim 16, wherein the retractable leash comprises a lighting apparatus on its surface.
